(19) United States
(12) Patent Application Publication
(10) Pub. No.: US 2003/0028735 A1
(43) Pub. Date: Feb. 6, 2003

(54) Priority encoder and method for priority address encoding

(76) Inventor: Ching-Hua Hsiao, Hsin-Chu (TW)

Correspondence Address: BIRCH STEWART KOLASCH & BIRCH, PO BOX 747, FALLS CHURCH, VA, 22040-0747, US

(21) Appl. No.: 10/117,234

(22) Filed: Apr. 8, 2002

(30) Foreign Application Priority Data
Jul. 17, 2001 (TW) 90117409

(51) Int. Cl. G06F 12/00

(52) U.S. Cl. 711/158; 711/217; 711/220

(57) ABSTRACT

The present invention provides a priority encoder comprising a first, second and third resolving-encoding circuit, each of which has a plurality of input terminals receiving a plurality of requests, determines one of the input terminals receiving one of the requests as a prior terminal, and outputs a forward request and an address of the prior terminal, wherein the forward requests of the first and second resolving-encoding circuit are received as the requests of the third resolving-encoding circuit, and a multiplexer receiving the addresses output from the first and second resolving-encoding circuit, and selectively outputting one of the received addresses according to the prior terminal determined by the third resolving-encoding circuit.

### BACKGROUND OF THE INVENTION

1. Field of the Invention

The present invention relates to a priority encoder, particularly to a hierarchical priority encoder with a multiple response resolver and high encoding speed.

2. Description of the Prior Art

Associative memories, that is, fully parallel CAMs (Content Addressable Memories), are widely known as semiconductor storage circuits having the functions of performing match detection of retrieval data and stored data concurrently in terms of all bits and outputting the match address of stored data or stored data.

Content-addressed retrieval, instead of retrieval by means of physical memory addresses, is common to content addressable memories (CAMs). Therefore, the basic function of CAM, unlike an ordinary memory, is to input retrieval data so as to output a word address at which data matching the retrieval data has been stored. However, only one word may not necessarily match, and there may be a plurality of them. When the plurality of match words are obtained in this manner, a correct encode output is unavailable with an ordinary encoder. Consequently, it is necessary to assign a proper priority to a signal before the signal is applied to an ordinary binary encoder so that only one signal is at an ON potential, the signal being sequentially switched to another in synchronization with a clock signal.

A priority encoder is disclosed in U.S. Pat. No.5555397 as shown in FIG. 1. The priority encoder 10 comprises a resolving circuit 12 for sequentially outputting signals, each including only one match signal or request with a predetermined priority, on receiving a number of input signals having a plurality of match signals or requests, and an encoding circuit 14 for encoding a match signal address existing in the output signal thus delivered sequentially.

The resolving circuit 12 has a ternary hierarchy: the tier of the lowest order comprises sixteen 4-input resolvers 16; the intermediate tier comprises four similar 4-input resolvers 18; and the tier of the highest order comprises one similar 4-input resolver 20. Therefore, the resolving circuit 12 is allowed to have 64 inputs because of sixteen resolvers 16 in the tier of the lowest order. In other words, 64 inputs of the circuit 12 are formed into 16 groups, each having four inputs. The resolver 16 is formed with a group of four inputs and 16 resolvers are employed. The 16 resolvers are formed into four groups, one group comprising four resolvers 16. The four resolvers 16 constituting the one group are connected to one resolver 18 forming the intermediary tier. Moreover, four of the resolvers 18 are formed into a group and connected to the resolvers 20 in the tier of the highest order.

The operation of the resolver 18₀ will be explained as an example.

The resolver 18₀ has four input terminals a, b, c and d respectively receiving 4 requests Or0, Or1, Or2 and Or3. The order of the four input terminals according to their priorities from high to low are a, b, c and d. When the resolver 18₀ receives only one request through the input terminal a, for example, the resolver 18₀ simply defines the input a as a prior terminal. When the resolver 18₀ receives two requests through the input terminal b and c, for example, the resolver 18₀ defines the input b as a prior terminal since the priority of terminal b is higher than that of terminal c. The resolver 18₀ has four output terminals corresponding to the four input terminals a, b, c and d. The signals e0, e1, e2 and e3 are output through the four output terminals when the input terminals a, b, c and d are defined as the prior terminal, respectively. Further, the resolver 18₀ outputs a forward signal OR₀ as long as a request is received through any one of the four input terminals a, b, c and d. A signal E1 is also received for activation of the resolver 18₀.

The forward signal OR₀ is transferred to the resolver 20 of the next tier as requests and competes with other forward signals OR₁˜OR₃. The signals e0˜e3 are sent back to the previous tier for activation of the resolvers 16₀˜16₃. Thus, when the prior terminal of the resolver 20 of the highest tier is defined, all the resolvers not receiving any request or transferring a forward signal losing in the competitions are shut down so that only one activated resolver remains in each tier.

The encoding circuit 14 receives the forward signals of the activated resolvers in each tier and generates their corresponding addresses which constitute a priority address.

However, in the previous described priority encoder, the inputting of the requests in competition for the next priority encoding is prohibited until the current priority encoding is finished since all the resolvers must wait for the feedback of the activation signals which are almost generated with the current priority address in the same time. That is to say, the priority addresses are generated absolutely serially and durations of the encoding of successively generated priority addresses must not overlap. This is a disadvantage for improvement of the encoding speed.

### SUMMARY OF THE INVENTION

Therefore, the object of the present invention is to provide a priority encoder which allows overlapping of the durations of two successively generated addresses.

The present invention provides a priority encoder comprising a first, second and third resolving-encoding circuit, each of which has a plurality of input terminals receiving a plurality of requests, determines one of the input terminals receiving one of the requests as a prior terminal, and outputs a forward request and an address of the prior terminal, wherein the forward requests of the first and second resolving-encoding circuit are received as the requests of the third resolving-encoding circuit, and a multiplexer receiving the addresses output from the first and second resolving-encoding circuit, and selectively outputting one of the received addresses according to the prior terminal determined by the third resolving-encoding circuit.

The present invention further provides a method for priority address encoding comprising the steps of receiving a plurality of requests through a first and second group of input terminals, determining two of the input terminals individually receiving two of the requests as a first and second prior terminal for the first and second group of the input terminals, and generating addresses of the first and second prior terminals and two forward requests individually corresponding to the first and second group of the input terminals receiving the forward requests through a third group of input terminals, determining one of the input terminals of the third group receiving one of the forward requests as a third prior terminal, and generating an address of the third terminal, and receiving the addresses of the first and second prior terminals, and selectively outputting one of the received addresses according to the third prior terminal.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 is a block diagram showing a conventional priority encoder.

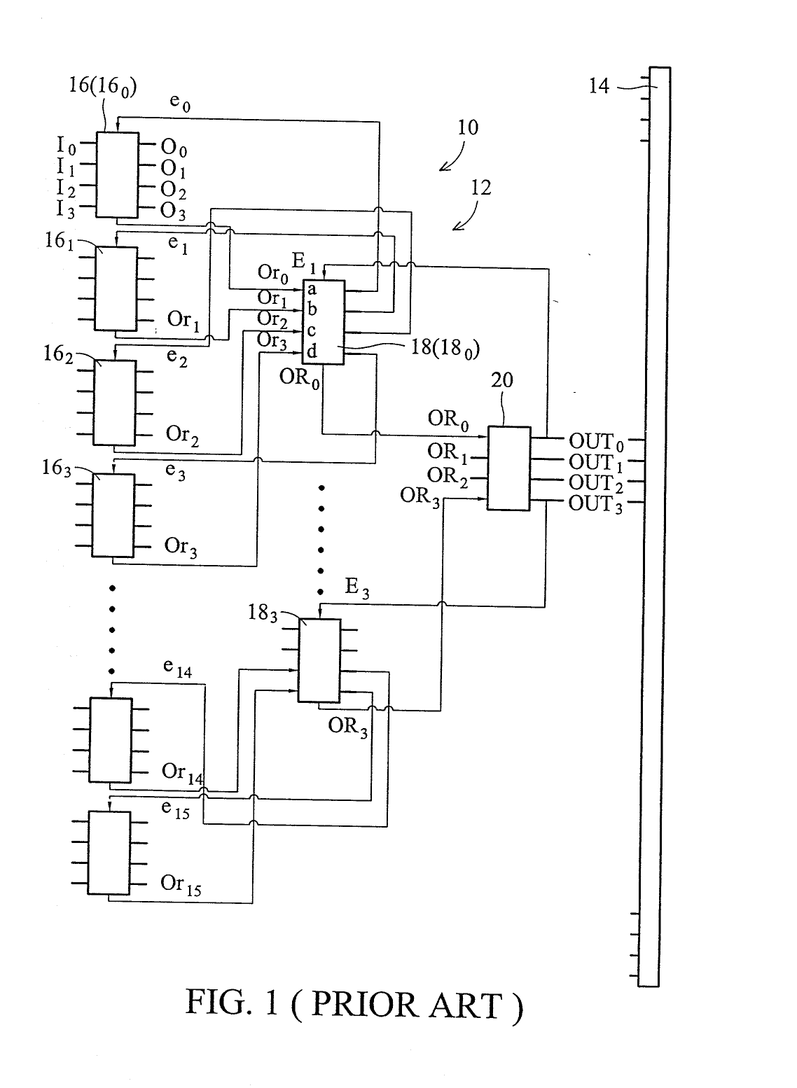

FIG. 2 is a block diagram showing a resolving-encoding circuit according to a first embodiment of the invention.

FIG. 3 is a block diagram showing a tier of multiplexers of a multiplexer circuit according to a first embodiment of the invention.

FIG. 4 is a block diagram showing a resolver according to a first embodiment of the invention.

FIG. 5 is a block diagram showing a priority encoder according to a second embodiment of the invention.

FIG. 6 is a block diagram showing a priority encoder according to a third embodiment of the invention.

FIG. 7 is a flow chart showing a method for priority address encoding according to one embodiment of the invention.

### DETAILED DESCRIPTION OF THE INVENTION

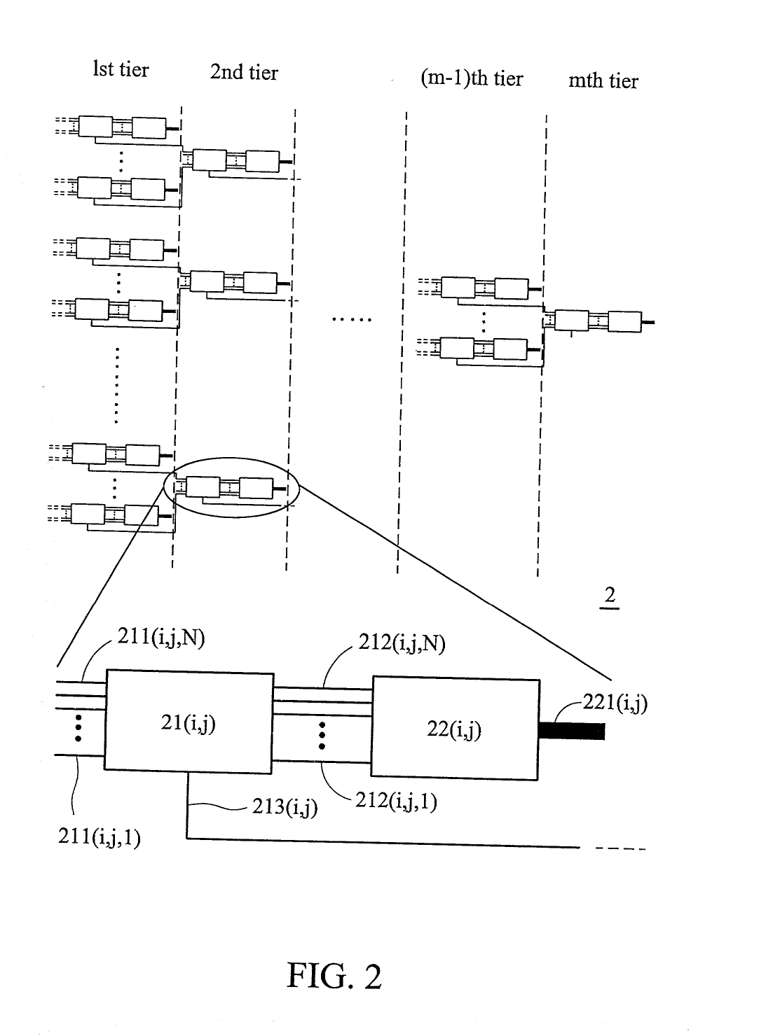

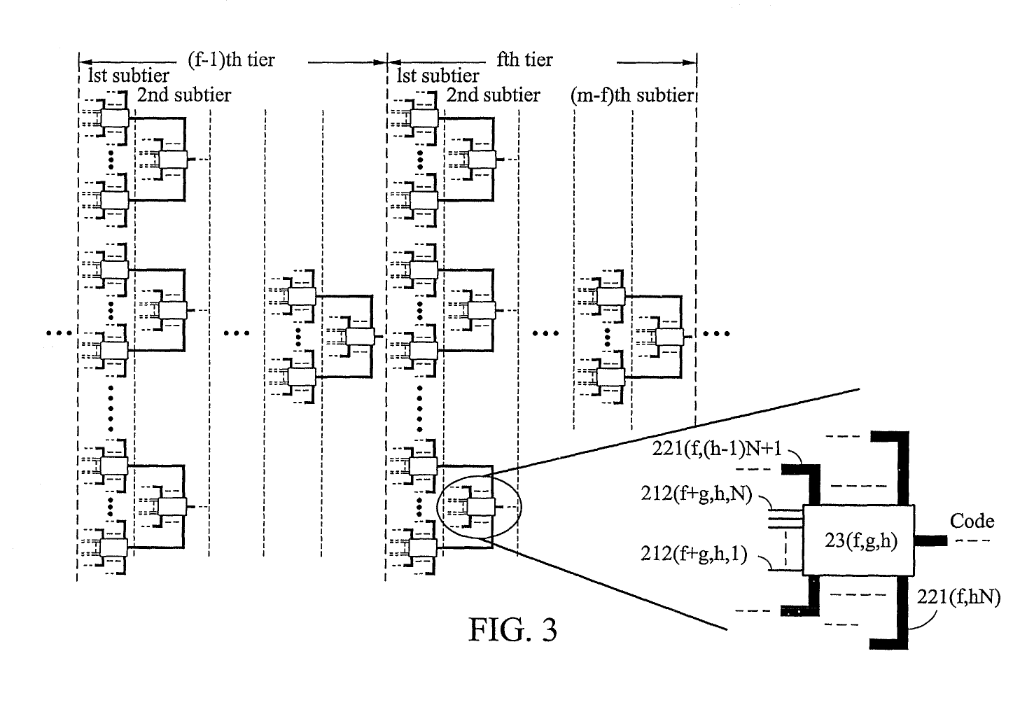

FIG. 2 and 3 are a block diagrams showing a priority encoder according to a first embodiment of the invention.

The priority encoder comprises an m-tier resolving-encoding unit 2 and an (m−1)-tier multiplexing unit 3.

As shown in FIG. 2, the resolving-encoding unit 2 comprises m tiers of resolving-encoding circuit composed of a resolver 21 and an encoder 22. Tier i of the resolving-encoding circuit has N^{(m-i)} resolvers 21 and encoders 22, wherein resolver and encoder j are respectively represented by 21 (i,j) and 22 (i,j). The resolver 21 (i,j) has N input terminals 211, N corresponding output terminals 212 and a forward request terminal 213, wherein input terminal k, output terminal and the forward request terminal of resolver j in tier i are respectively represented by 211 (i,j,k), 212 (i,j,k) and 213 (i,j). One or more requests are received by the input terminals 21 (i,j,1)˜21 (i,j,N), a resolution is output by one of the output terminals 21 (i,j,1)˜(i,j,N) and a forward request is output by the forward request terminal 213 (i,j). The order of the input terminals 211 according to their priorities from high to low is 211 (i,j,N) , . . . , 211 (i,J,2) and 211 (i,j,1). The encoder 22 (i,j) receives the resolution from one of the output terminals 212 (i,j,1)˜212 (i,j,N) and outputs an address Code (i,j,k) through the address terminal 221 (i,j) if the resolution is from the output terminal 212 (i,j,k).

The operation of the resolver 21 (i,j) and encoder 22 (i,j) is explained following.

1. When the resolver 21 (i,j) does not receive any request, there is no resolution, forward request and address generated.

2. When the resolver 21 (i,j) receives only one request through the input terminal 211 (i,j,k), the forward request is output through the terminal 213 (i,j) and the resolution is output through the terminals 212 (i,j,k). The encoder 22 (i,j) receives the resolution and outputs the address Code (i,j,k).

3. When the resolver 21 (i,j) receives more than one request through the input terminals 211 (i,j,k1) and 211 (i,j,k2) for example, the resolver determines one of the terminals 211 (i,j,k1) and 211 (i,j,k2) which has the highest priority as a prior terminal (assumed to be the terminal 211 (i,j,k1)). The resolution is also output through the terminals 212 (i,j,k). The encoder 22 (i,j) receives the resolution and outputs the address Code (i,j,k1).

The forward request output from the terminals 212 (i,j,1)˜212 (i,j,N) are transferred as the requests of the next tier.

As shown in FIG. 3, the multiplexing unit 3 comprises (m−1) tiers wherein tier f comprises (m−f) sub-tiers. Sub-tier g of tier fhas N^{(m-f-g)} multiplexers 23 wherein the hₜₕ multiplexer of the gₜₕ sub-tier of tier f is represented by 23 (f,g,h). The multiplexer 23 (f,g,h) receives the resolution output from one of the terminals 212 (f+g,h,1)˜212 (f+g,h,N) of the resolver 21 (f+g,h). Specifically, the multiplexer h of the first sub-tier of tier f represented as 23 (f,l,h) receives the addresses from the encoders 22 (f,(h−1) ×N+1)˜22 (f,h×N) and selectively outputs one of the received addresses corresponding to the terminal through which the resolution is received. As for the other sub-tiers, the hₜₕ multiplexer of the gₜₕ sub-tier of the fₜₕ tier represented as 23 (f,g,h) receives the addresses from the multiplexers 23 (f, (g−1), (h−1)×N+1)˜23 (f, (g−1),h×N) and selectively outputs one of the received addresses corresponding to the terminal through which the resolution is received.

Thus, the multiplexing unit 3 determines an address for each of the tier in the resolving-encoding unit 2. A priority address is obtained by combining the addresses of each tier in the resolving-encoding unit 2.

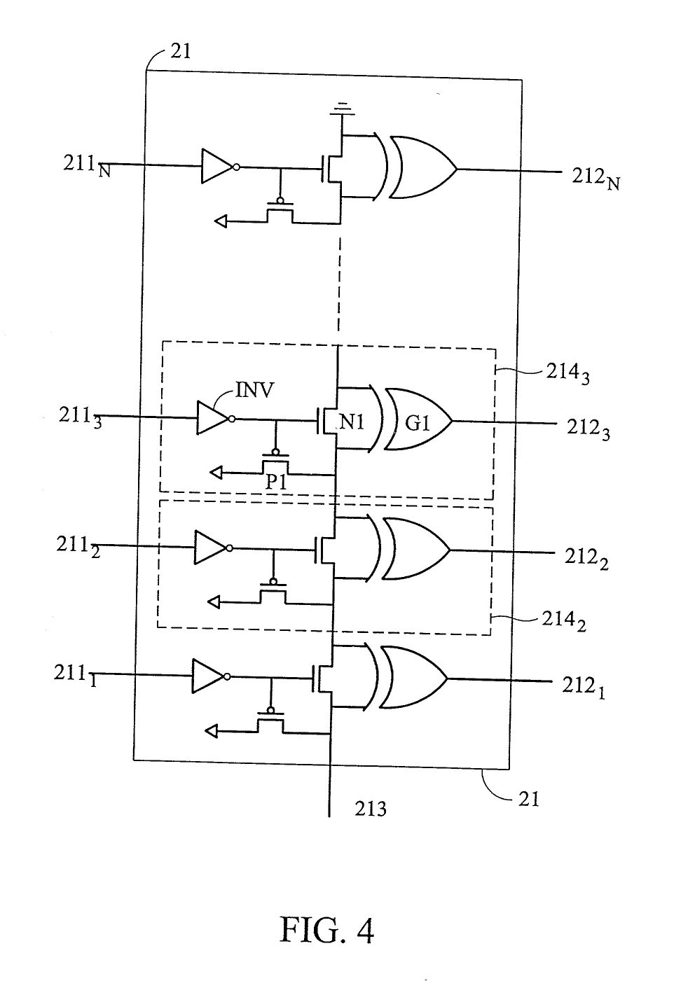

FIG. 4 is a block diagram showing the resolver of the priority encoder. The resolver 21 comprises N unit circuits 214, each of which has an inverter INV, a P type transistor P1, a N type transistor N1 and a NOR gate G1. The inverter INV receives the request through the input terminals 211 and is connected to the gates of the transistor P1 and N1. The source of the transistor P1 is connected to one of the inputs of the NOR gate G1 and the drain is connected to receive a high voltage level. The source and drain of the transistor N1 are connected to the two inputs of the NOR gate G1. The output terminal of the NOR gate G1 is the terminal for outputting the resolution. In the upmost unit circuit 214 in FIG. 4, one of the inputs of the NOR gate G1 is connected to ground. In the lowest unit circuit 214 in FIG. 4, one of the inputs of the NOR gate G1 is the terminal for outputting the forward request.

The operation of the unit circuit 214 is explained in the following.

1. When there is no request, the transistor P1 is turned off and the transistor N1 turned on so that the two inputs of the NOR gate G1 are both “0” and the terminals 212 and 213 also output “0”.

2. When there is only one request received by the terminal 211₃ for example, the transistor P1 of the unit circuit 214 is turned on and the transistor N1 turned off so that the inputs of the NOR gate are “0” and “1”, and “1” is output from the terminal 212₃. Since the transistors N1 of the other unit circuits 214 are turned on, the “1” on the lower input terminal of the NOR gate G1 of the circuit 214₃ is transferred to the terminal 213. The unit circuits above the circuit 214₃ operate as if there is no request received.

3. When there is more than one request received by the terminals 211₂ and 211₃ for example, the operation of the circuit 214₃ is the same as that described in (2). The requests received by all the other circuits 214 below the circuit 214₃ have no effect on the outputs of the terminals 212 and 213 so that the request received by the circuit 214₂ is ignored.

Thus, the order of the terminals 211 according to their priorities from high to low is 211ₙ, . . . 211₂ and 211₁. When there are more than one request, the requests other than that on the terminal with the highest priority are ignored.

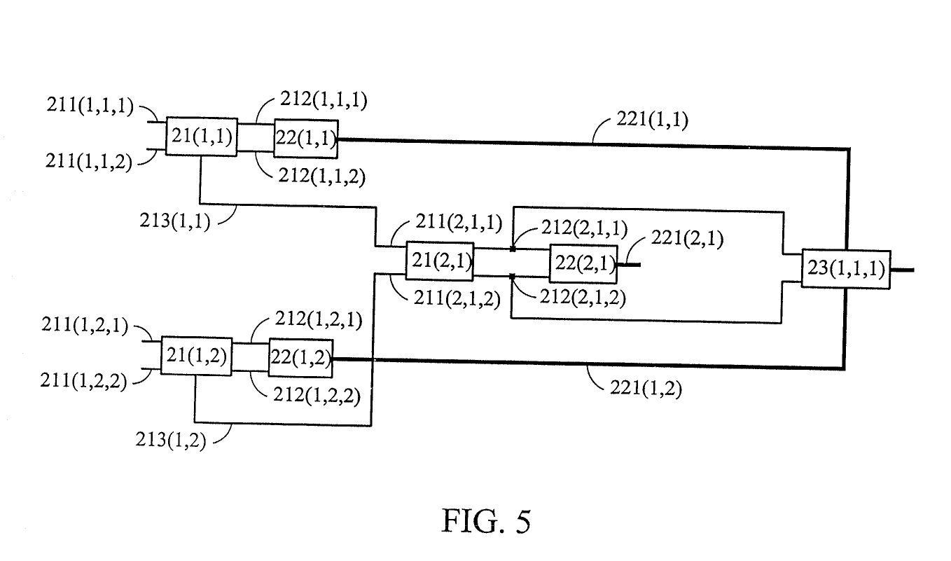

FIG. 5 is a block diagram showing a priority encoder according to a second embodiment of the invention, which is a two-tier (n=m=2) priority encoder of the first embodiment. The priority encoder 5 comprising two tiers of the resolving-encoding circuits and one tier of the multiplexing circuits. The first tier of resolving circuits comprises resolvers 21 (1,1) and 21 (1,2), and encoder 22 (1,1) and 22 (1,2). The second tier of the resolving-encoding circuits comprises a resolver 21 (2,1) and a encoder 22 (2,1). The tier of the multiplexing circuits comprises one sub-tier having a multiplexing circuit 23 (1,1,1).

The encoder 22 (2,1) generates addresses Code (1,1,1), Code (1,2,2) of the terminals 211 (1,2,1) and 211 (1,1,2) respectively. The encoder 22 (2,1) generates addresses Code (1,2,1) and Code (1,2,2) of the terminals 211 (1,2,1) and 211 (1,2,2) respectively. The encoder 22 (2,1) generates addresses Code (2,1,1) and Code (2,1,2) of the terminals 211 (2,1,1) and 211 (2,1,2) respectively. The Code (1,1,1), Code (1,1,2), Code (1,2,1), Code (1,2,2), Code (2,1,1) and Code (2,1,2) are 0,1,0,1,0 and 1 respectively.

The truth table for the four terminals 211 (1,1,1), 211 (1,1,2), 221 (1,2,1) and 211 (1,2,2), the addresses output from the encoder 22 (2,1) and the multiplexing circuit 23 (1,1,1) follows.

| | | | | | Address |
|---|---|---|---|---|---|
| | | | | Address | from |
| 211 | 211 | 211 | 211 | from | the multiplexing |
| (1,1,1) | (1,1,2) | (1,2,1) | (1,2,2) | the encoder | circuit |
| 0 | 0 | 0 | 0 | X | X |
| 0 | 0 | 0 | 1 | 1 | 1 |
| 0 | 0 | 1 | 0 | 0 | 1 |
| 0 | 0 | 1 | 1 | 0 | 1 |
| 0 | 1 | 0 | 0 | 1 | 0 |
| 0 | 1 | 0 | 1 | 1 | 0 |
| 0 | 1 | 1 | 0 | 1 | 0 |
| 0 | 1 | 1 | 1 | 1 | 0 |
| 1 | 0 | 0 | 0 | 0 | 0 |
| 1 | 0 | 0 | 1 | 0 | 0 |
| 1 | 0 | 1 | 0 | 0 | 0 |
| 1 | 0 | 1 | 1 | 0 | 0 |
| 1 | 1 | 0 | 0 | 0 | 0 |
| 1 | 1 | 0 | 1 | 0 | 0 |
| 1 | 1 | 1 | 0 | 0 | 0 |
| 1 | 1 | 1 | 1 | 0 | 0 |

The priority address is obtained by combining the addresses output from the encoder 22 (2,1) and the multiplexing circuit 23 (1,1,1).

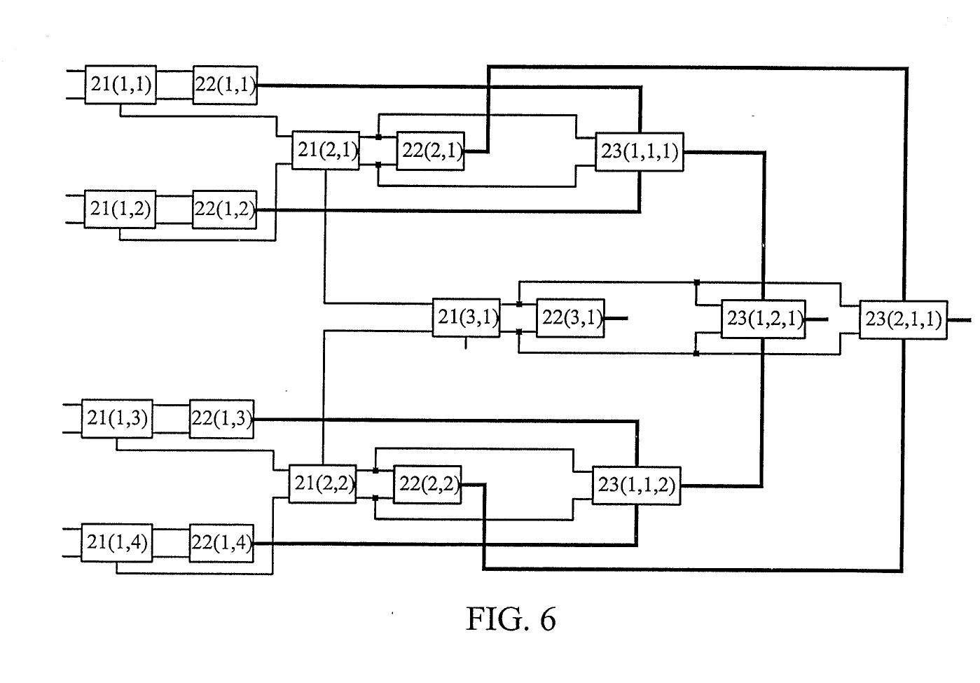

FIG. 6 is a block diagram showing a priority encoder according to a third embodiment of the invention, which is a three-tier (n=2, m=3) priority encoder of the first embodiment. The priority encoder 6 comprises three tiers of the resolving-encoding circuits and two tier of the multiplexing circuits. The first tier of resolving circuits comprises resolvers 21 (1,1), 21 (1,2), 21 (1,3) and 21 (1,4), and encoder 22 (1,1), 22 (1,2), 22 (1,3) and 22 (1,4). The second tier of the resolving-encoding circuits comprises resolvers 21 (2,1) and 21 (2,2), and encoders 22 (2,1) and 22 (2,2). The third tier of the resolving-encoding circuits comprises a resolver 21 (3,1) and a encoder 22 (3,1). The first tier of the multiplexing circuits comprises two sub-tiers wherein the first sub-tier has a multiplexing circuit 23 (1,1,1) and 23 (1,1,2) and the second sub-tier has a multiplexing circuit 23 (1,2,1). The second tier of the multiplexing circuits comprises one sub-tier having a multiplexing circuit 23 (2,1,1).

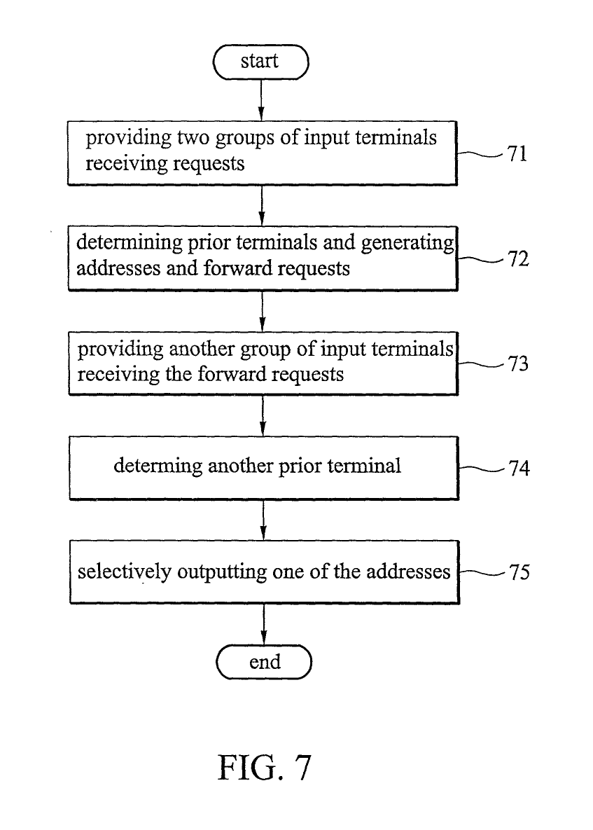

FIG. 7 is a flow chart showing a method for priority address encoding according to one embodiment of the invention.

In step 71, two groups of input terminals are provided and each group can receive more than one request. Each of the input terminals is assigned a priority.

In step 72, for each group of the input terminals, when the requests are received, a prior terminal is determined according to the priorities of the input terminals receiving the requests, and a forward request and an address of the prior terminal is generated.

In step 73, another group of input terminals which can receive the forward requests generated in step 71 is provided and each of the input terminals is assigned a priority.

In step 74, when there is a forward request, a prior terminal is determined according to the priorities of the input terminals receiving the forward requests, and an address of the prior terminal is generated.

In step 75, the addresses of the prior terminals for the groups of the input terminals generated in step 72 are received and selectively output according to the prior terminal determined in step 74.

Thus, a priority address is obtained by combining the addresses generated in step 74 and 75.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A priority encoder comprising:
a first, second and third resolving-encoding circuit, each of which has a plurality of input terminals receiving a plurality of requests, determines one of the input terminals receiving one of the requests as a prior terminal, and outputs a forward request and an address of the prior terminal, wherein the forward requests of the first and second resolving-encoding circuit are received as the requests of the third resolving-encoding circuit; and
a multiplexer receiving the addresses output from the first and second resolving-encoding circuit, and selectively outputting one of the received addresses according to the prior terminal determined by the third resolving-encoding circuit.

2. The priority encoder as claimed in claim 1 wherein each of the resolving-encoding circuits further comprises:
a resolver having the input terminals receiving the requests and determining one of the input terminals receiving one of the requests as the prior terminal; and an encoder generating the address of the prior terminal.

3. The priority encoder as claimed in claim 1 wherein a priority is assigned to each of the input terminals and each of the resolving-encoding circuits determines the prior terminal according to the priorities.

4. The priority encoder as claimed in claim 1 wherein a priority address is composed of the addresses output from the third resolving-encoding circuit and the multiplexer.

5. A method for priority address encoding comprising the steps of:
receiving a plurality of requests through a first and second group of input terminals;
determining two of the input terminals individually receiving two of the requests as a first and second prior terminal for the first and second group of the input terminals, and generating addresses of the first and second prior terminals and two forward requests individually corresponding to the first and second group of the input terminals;
receiving the forward requests through a third group of input terminals;
determining one of the input terminals of the third group receiving one of the forward requests as a third prior terminal, and generating an address of the third terminal; and
receiving the addresses of the first and second prior terminals, and selectively outputting one of the received addresses according to the third prior terminal.

6. The method as claimed in claim 5 wherein a priority is assigned to each of the input terminals and each of the prior terminals are determined according to the priorities.

7. The method as claimed in claim 5 further comprising the step of:
generating a priority address by combining the address of the third prior terminal and the output address selected from the addresses of the first and second prior terminals.
